(19) United States
(12) Patent Application Publication
(10) Pub. No.: US 2018/0043477 A1
(43) Pub. Date: Feb. 15, 2018

(54) NI-MN-CR-AL-TI-ALLOY, POWDER, METHOD AND COMPONENT

(71) Applicant: SIEMENS AKTIENGESELLSCHAFT, MÜNCHEN (DE)

(72) Inventor: BRITTA LAUX, BERLIN (DE)

(21) Appl. No.: 15/557,173

(22) PCT Filed: Mar. 14, 2016
(86) PCT No.: PCT/EP2016/055395

§ 371 Date: Sep. 11, 2017

(30) Foreign Application Priority Data
Mar. 16, 2015 (DE) 10 2015 204 726.1

(51) Int. Cl. B23K 35/30; B23K 1/00; B22F 7/06; C22C 19/05; C22C 19/00; B23K 35/02; B32B 15/01

(52) U.S. Cl. CPC B23K 35/3033; B23K 35/0244; B23K 1/0018; B32B 15/01; C22C 19/058; C22C 19/005; B22F 7/062; B22F 2007/068

(57) ABSTRACT

Provided is a soldering system based on nickel, manganese, chromium, aluminum and titanium, a fracture free alternative to the soldering of nickel or cobalt-based alloys is created. Disclosed is an alloy which comprises, as alloy elements, at least the following (in % by weight): manganese, in particular from 10%-16%, very particularly preferably from 12% to 15%, chromium, in particular from 3% to 10%, very particularly preferably from 5% to 8%, aluminum, in particular from 1% to 6%, very particularly preferably from 2% to 4%, titanium, in particular from 1% to 6%, very particularly preferably from 2% to 4%, nickel, in particular nickel as balance, very particularly preferably nickel-based.

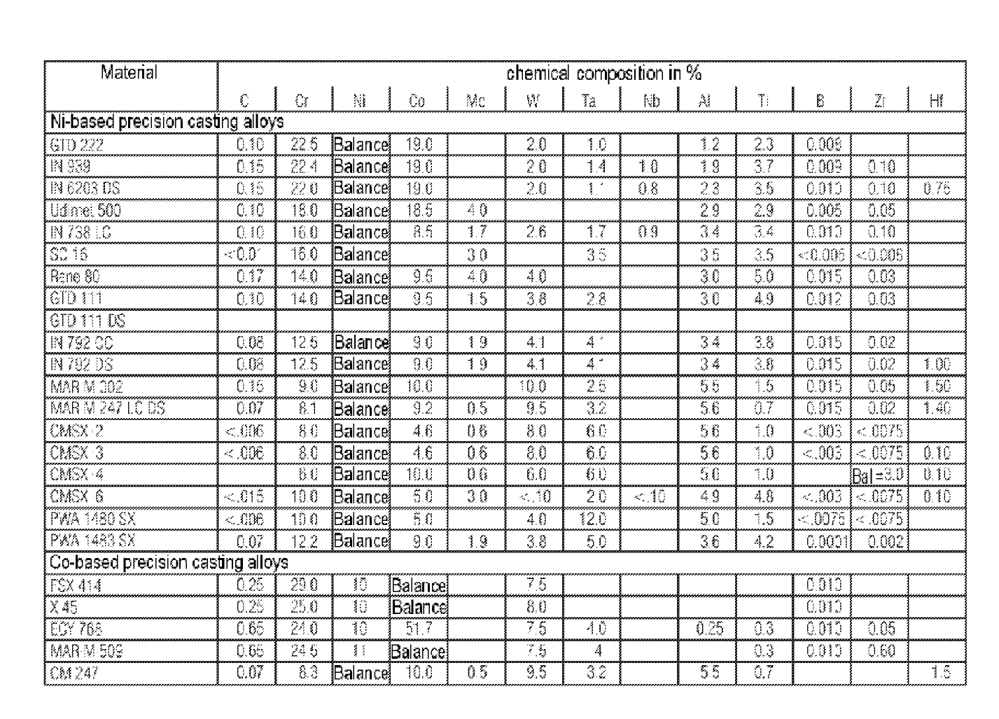

### CROSS-REFERENCE TO RELATED APPLICATIONS

This application claims priority to PCT Application No. PCT/EP2016/055395, having a filing date of Mar. 14, 2016, based off of German application No. 10 2015 204726.1 having a filing date of Mar. 16, 2015, the entire contents both of which are hereby incorporated by reference.

### FIELD OF TECHNOLOGY

The following relates to an alloy which is, in particular, used for soldering and is based on nickel, manganese, chromium, aluminum and titanium, a powder or raw material, a method and a component.

### BACKGROUND

Boron-containing solder systems are normally used for repair soldering such as buildup soldering and crack soldering of high-temperature turbine components. Either solder pastes or presintered solder sheets which consist of a mixture of a boron-containing solder powder and a base material powder are generally used for this purpose. The base material powder is mixed in in order to serve as diffusion sink for boron (B). In an additional heat treatment, which is carried out after the actual soldering operation, the boron diffuses into the base material of the component and at the same time into the added base material powder.

A problem associated with this process is the long hold times which are necessary for sufficient diffusion. If this diffusion time is not adhered to, borides are formed due to the extremely low solubility of boron (B) in nickel (Ni), and these significantly impair the mechanical properties of the solder bond. Furthermore, there are initial indications that undesirable interactions with an MCrAlY coating occur in the long term in the case of boron-containing solders.

It is known that good mechanical properties can be achieved when using the boron-containing solders, as long as appropriately long heat treatment cycles are allowed for. These costs are at present accepted in the context of component repair.

### SUMMARY

An aspect of the embodiments disclosed is to solve the above problem. Provided is a soldering system based on nickel (Ni), manganese (Mn), chromium (Cr), aluminum (AI) and titanium (Ti), a fracture free alternative to the soldering of nickel or cobalt-based alloys is created. Disclosed is an alloy which comprises, as alloy elements, at least the following (in % by weight): manganese, in particular from 10%-16%, very particularly preferably from 12% to 15%, chromium, in particular from 3% to 10%, very particularly preferably from 5% to 8%, aluminum, in particular from 1% to 6%, very particularly preferably from 2% to 4%, titanium, in particular from 1% to 6%, very particularly preferably from 2% to 4%, nickel, in particular nickel as balance, very particularly preferably nickel-based.

### BRIEF DESCRIPTION

Some of the embodiments will be described in detail, with references to the following FIGURES, wherein like designations denote like members, wherein:

The FIGURE shows a list of cobalt- or nickel-based superalloys.

### DETAILED DESCRIPTION

It is proposed that the boron-containing solders be replaced by manganese-containing systems which are preferably based on the following base system: Ni—Mn—Cr—Al—Ti.

Here, manganese (Mn) functions as main melting point reducer, titanium (Tr) functions as additional melting point reducer and serves to stabilize γ′, aluminum (Al) functions as γ′ former and chromium (Cr) functions as mixed crystal hardener and serves to improve the oxidation/corrosion resistance.

A preferred composition is Ni, 12-15Mn, 5-8Cr, 2-4Al, 2-4Ti (in % by weight).

The solder has a very simple make-up in terms of the composition and the phases present. The melting range is from 1453K to 1508K in the case of the composition Ni-15Mn-8Cr-3Al-3Ti and can be shifted in a targeted manner by adaptation of the proportion of manganese. Between the solidus temperature and the γ′ solvus temperature, there is a sufficiently wide window for solution heat treatment, which in the case of repair of a component comprising Rene 80 using this alloy can be carried out during the first two ageing stages for the base material.

Further base materials are listed in the FIGURE.

The γ′ solvus temperature of the alloy can optionally also be varied by varying the titanium content and aluminum content.

The solder can preferably be applied in powder form with or without additional base material powder, in particular of a substrate of a component to be repaired. Since no boron diffusion is required, the entire solder heat treatment after the actual soldering becomes unnecessary. In the case of Rene 80, soldering could be integrated directly into a required component heat treatment of the Rene 80 (1477K, 2h).

If the components are to be repaired a number of times, it is possible to use a system having a relatively low proportion of Mn (about 12%), so that soldering can be carried out above the solution heat treatment temperature (at 1483K-1493K). The actual soldering could be carried out in 1 hour; further heat treatment steps are no longer necessary after this.

If relatively high-strength materials such as Alloy 247 are to be soldered, the melting point and the γ′ solvus temperature can be adapted.

Since manganese (Mn) has a very good solubility in nickel, manganese (Mn) as melting point reducer does not have to be diffused out in order to avoid brittle phase formation. Renewed solution heat treatment of previously soldered components is possible, as long as a sufficiently low proportion of manganese is set in the solders so that the remelting temperature is high enough.

Compared to boron-containing systems, the following advantages are obtained:

shortening of the process times since no diffusion is necessary,

no risk of brittle phase formation since manganese (Mn) and nickel (Ni) have very good compatibility,

mechanical properties of the manganese solders have already been examined and are comparable to those of the boron-containing solders,

simplified solder application in the case of crack soldering,

very simple base system which can be tailored to various base materials.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. An alloy which comprises, as alloy elements, at least the following
in % by weight:
manganese
from 10%-16%,
chromium
from 3% to 10%,
aluminum
from 1% to 6%,
titanium
from 1% to 6%, and
nickel as a balance.

2. The alloy as claimed in claim 1 comprising 3% by weight of aluminum.

3. The alloy as claimed in claim 1, comprising 3% by weight of titanium.

4. The alloy as claimed in claim 1, comprising 15% by weight of manganese.

5. The alloy as claimed in claim 1, comprising 8% by weight of chromium.

6. The alloy as claimed in claim 1, wherein the alloy consists of nickel, manganese, chromium, aluminum and titanium.

7. The alloy as claimed in claim 1
which comprises no boron
and/or no germanium
and/or no gallium
and/or no silicon.

8. A powder or raw material comprising an alloy as claimed in claim 1,
in particular consisting thereof.

9. The powder as claimed in claim 8 which comprises a physical mixture of a powder or of an alloy and a manganese-free nickel-based powder.

10. A method of soldering a nickel-based component, wherein an alloy as claimed in claim 1 or a powder or raw material is used.

11. The method as claimed in claim 10, wherein the soldering temperature is in the range from 1453K to 1508K.

12. The method as claimed in claim 10, wherein the soldering operation is integrated into a heat treatment of a component which is necessary for use of the component,
when the component comprises Rene.

13. A component comprising a nickel- or cobalt-based substrate, comprising Rene,
which has at least and at most partly a buildup region and/or a repaired place comprising an alloy as claimed in claim 1.

14. The component as claimed in claim 13 comprising Alloy 247.

15. An alloy which comprises, as alloy elements, at least the following in % by weight: manganese from 12%-15%, chromium from 5% to 8%, aluminum from 2% to 4%, titanium from 2% to 4%, and nickel-based.
